(19) United States
(12) Patent Application Publication
(10) Pub. No.: US 2010/0138408 A1
(43) Pub. Date: Jun. 3, 2010

(54) Information Processing Apparatus and Information Processing Method

(75) Inventor: Satoshi Sera, Fuchu-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/495,381

(22) Filed: Jun. 30, 2009

(30) Foreign Application Priority Data
Dec. 2, 2008 (JP) 2008-307379

(51) Int. Cl. G06F 17/30

(52) U.S. Cl. 707/722; 707/E17.071

(57) ABSTRACT

According to an aspect of the present invention, there is provided an information processing apparatus including: an associated information acquiring module configured to acquire associated information of content selected from plural contents data; a first search module configured to search the contents data for first content having first associated information that is relevant to the associated information of the selected content; a second search module configured to search the contents data for second content having second associated information that satisfies a given condition; and a content display module configured to display the first content and the second content.

### CROSS-REFERENCE TO RELATED APPLICATIONS

This application is based upon and claims the benefit of priority from Japanese Patent Application No. 2008-307379, filed on Dec. 2, 2008, the entire contents of which are incorporated herein by reference.

### BACKGROUND

1. Field

An aspect of the present invention relates to an information processing apparatus and an information processing method.

2. Description of the Related Art

There is an information processing apparatus which presents stored unviewed contents in order according to tastes of the user (see JP-A-2008-66777, for instance).

This information processing apparatus is equipped with a content memory for storing contents data, a taste memory for accumulating pieces of taste information of the user, an unviewed content search module for searching the content memory for unviewed contents, and a taste-based order determining module for arranging the unviewed contents in order based on the pieces of taste information of the user, The user is allowed to efficiently view the unviewed contents accumulated in the content memory by successively reproducing the unviewed contents that are arranged in order.

However, in the information processing apparatus, contents with higher viewing priority to the user than other contents, for example, contents with no taste information accumulated for them, such as contents that were acquired with payment and contents for which viewing deadlines are set, are not necessarily given high ranks. Those contents may end up unviewed; for example, they may be charged without being viewed or rendered unviewable because of expiry of their viewing deadlines.

### BRIEF DESCRIPTION OF THE SEVERAL VIEWS OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 is an exemplary schematic diagram showing an appearance of an information processing apparatus according to an embodiment of the present invention;

FIG. 2 is an exemplary block diagram showing the configuration of the information processing apparatus according to the embodiment of the invention.

FIG. 3A schematically shows an example display of video that is output from the information processing apparatus according to the embodiment of the invention;

FIG. 3B schematically shows another example display of video that is output from the information processing apparatus according to the embodiment of the invention;

FIG. 3C schematically shows a further example display of video that is output from the information processing apparatus according to the embodiment of the invention; and

FIG. 4 is a flowchart showing an example operation of the information processing apparatus according to the embodiment of the invention.

### DETAILED DESCRIPTION

Various embodiments according to the present invention will be described hereinafter with reference to the accompanying drawings. In general, according to one embodiment of the present invention, there is provided an information processing apparatus including: an associated information acquiring module configured to acquire associated information of content selected from plural contents data; a first search module configured to search the contents data for first content having first associated information that is relevant to the associated information of the selected content; a second search module configured to search the contents data for second content having second associated information that satisfies a given condition; and a content display module configured to display the first content and the second content.

An information processing apparatus and an information processing method according to an embodiment of the present invention will be hereinafter described in detail with reference to the drawings.

(Configuration of Information Processing Apparatus)

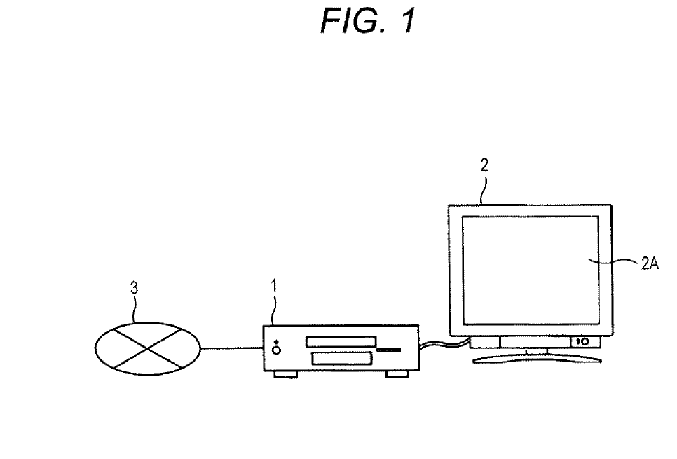

FIG. 1 is a schematic diagram showing an appearance of the information processing apparatus according to the embodiment of the invention.

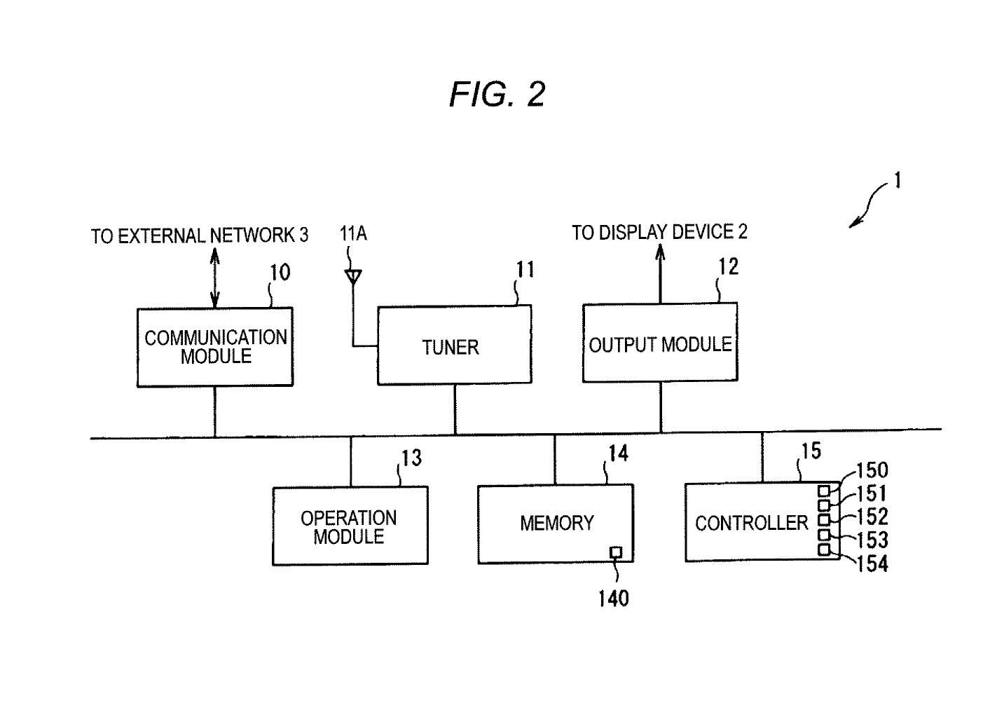

The information processing apparatus 1 is a video recording/reproducing apparatus which is connected to an antenna 11A (see FIG. 2), receives broadcast waves and outputs video and audio. The information processing apparatus 1 is also connected to an external network 3 such as the Internet via a local area network (LAN) cable or the like so as to be able to communicate with the outside. The information processing apparatus 1 outputs a video signal and an audio signal to a display device 2 such as a liquid crystal display (LCD) having a display screen 2A. The information processing apparatus 1 has a remote control signal reception module for receiving an operation signal that is transmitted from a remote controller having plural operation switches when an operation switch is operated. The information processing apparatus 1 is operated based on the operation signal.

FIG. 2 is a block diagram showing the configuration of the information processing apparatus 1 according to the embodiment of the invention.

The information processing apparatus 1 is equipped with a communication module 10 which communicates with a video content distributing server (not shown) over the external network 3, a tuner 11 which receives digital broadcast waves from the outside via the antenna 11A and demodulates the received digital broadcast waves and receives a transport stream selectively, an output module which outputs, to the display device 2, a video signal and an audio signal that are output from a controller 15 (described later), an operation module 13 which is an operation device including the remote controller and the remote control signal reception module, a memory 14 such as a hard disk drive (HDD) which stores information as typified by video contents 140, and the controller 15 which has a central processing unit (CPU) etc. and has a video processing function of decoding a transport stream received by the tuner 11 and outputs a video signal and an audio signal. The controller 15 operates an associated information acquiring module 150, a relevant content search module 151 (first search module), an unviewed content search module 152 (second search module), a viewing deadline search module 153 (second search module) and a content display module 154.

The associated information acquiring module 150 is a module for acquiring associated information including a title name, a genre, a cast, a price, etc. of each video content 140. The relevant content search module 151 is a module for calculating a degree of relevance by comparing associated information of a video content selected by the user and that of each of the other video contents. The unviewed content search module 152 is a module for searching for unviewed video contents. The viewing deadline search module 153 is a module for searching for viewing deadlines of video contents. The content display module 154 is a module for performing processing of displaying a thumbnail, a title, etc. of each content.

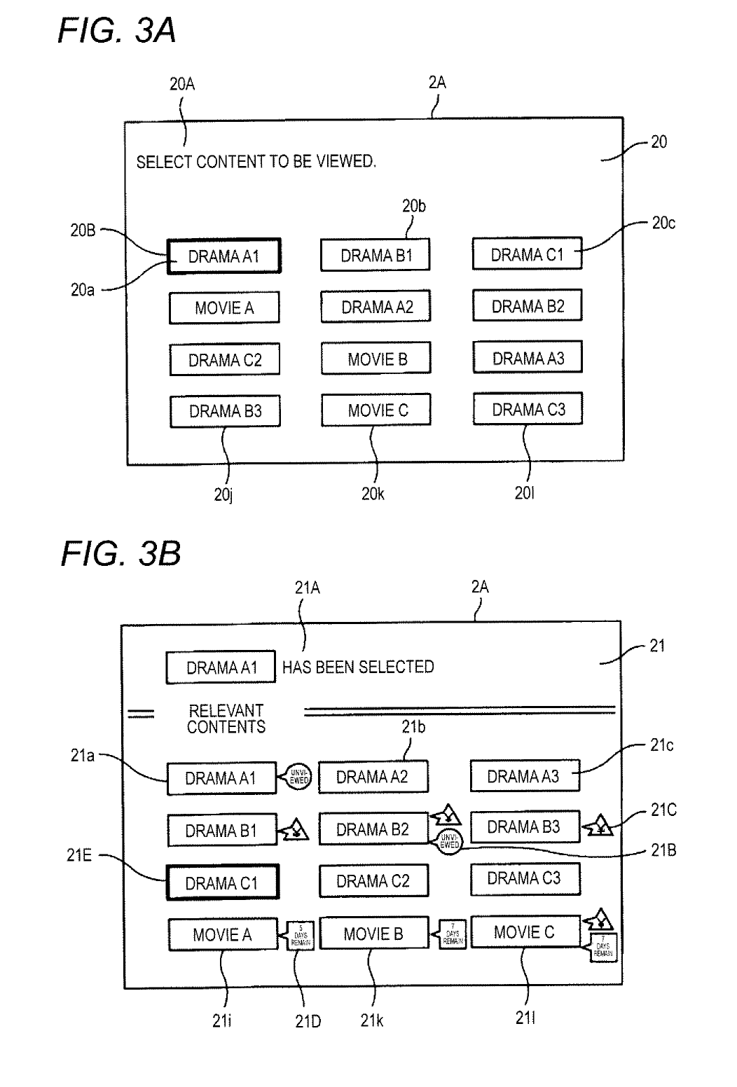

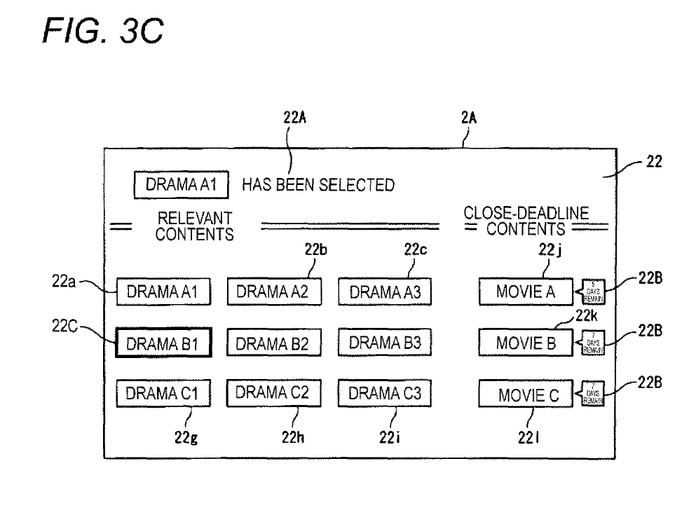

FIG. 3A schematically shows an example display of video that is output from the information processing apparatus 1 according to the embodiment of the invention.

A content selection screen 20 is displayed on the display screen 2A when the user attempts to view video contents 140 stored in the memory 14. The content selection screen 20 has a message 20A “select content to be viewed” which urges user operation, a selection frame 20B which allows the user to select a video content to be viewed and which moves according to an input to the operation module 13 by the user, and video contents 20a-20l as subjects of selection. For example, at first, the video contents 20a-201 are displayed in such order that a video content that was recorded last is given the highest priority.

FIG. 3B schematically shows another example display of video that is output from the information processing apparatus 1 according to the embodiment of the invention.

A relevant content display screen 21 is displayed on the display screen 2A after the user selects a video content through the content selection screen 20 of FIG. 3A. The content selection screen 21 has a message 21A “◯◯ has been selected” which allows the user to confirm the selected video content, unviewed content indications 21B which are displayed in association with unviewed video contents, pay content indications 21C which are displayed in association with pay video contents, deadline indications 21D which are displayed in association with video contents for which the numbers of days to their viewing deadlines are smaller than or equal to a predetermined number (together with the numbers of remaining viewable days), a selection frame 21E which allows the user to select a video content to be viewed, and video contents 21a-21l that have been rearranged based on the associated information of the video content that was selected through the content selection screen 20.

FIG. 3C schematically shows a further example display of video that is output from the information processing apparatus 1 according to the embodiment of the invention.

A relevant content display screen 22 is an alternative to the screen 21 of FIG. 3 and is displayed so that “relevant contents” and “video contents whose deadlines are close” are displayed differently. The relevant content display screen 22 has a message 22A, deadline indications 22B, a selection frame 22C, and video contents 22a-22l.

(Operation)

An operation of the information processing apparatus 1 according to the embodiment of the invention will be described below with reference to the drawings.

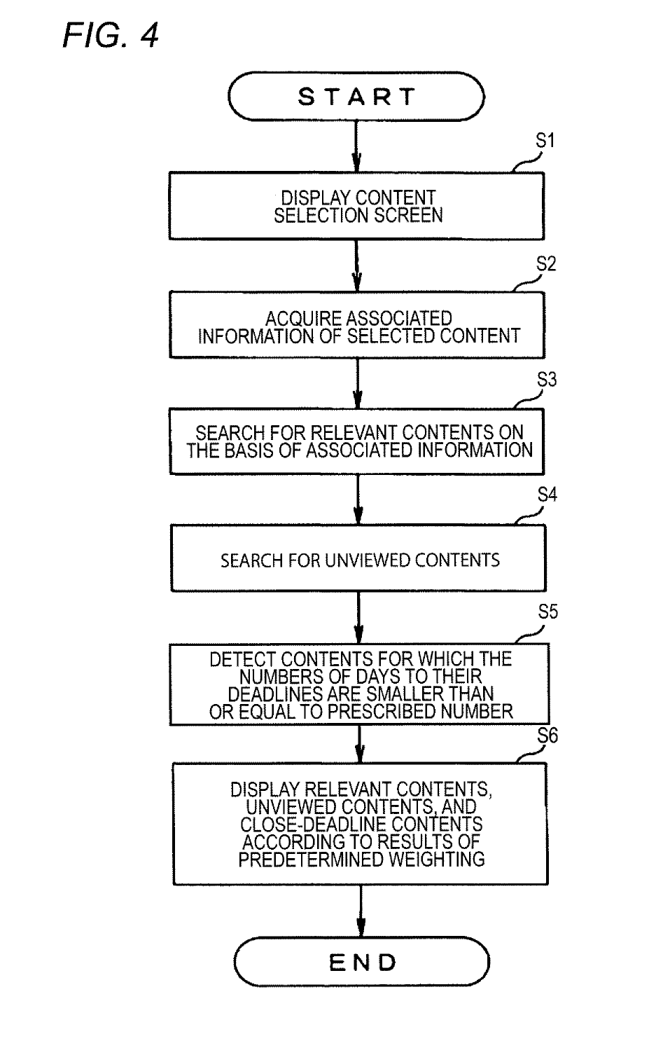

FIG. 4 is a flowchart showing an example operation of the information processing apparatus 1 according to the embodiment of the invention.

First, if the user carries out an operation for displaying video contents 140 stored in the memory 14 using the remote controller, for example, at step S1, the content display module 154 of the controller 15 of the information processing apparatus 1 displays a content selection screen 20 as shown in FIG. 3A on the display screen 2A of the display device 2. If the user selects a desired video content through the content selection screen 20 using the selection frame 20B, at step S2, the associated information acquiring module 150 acquires associated information of the video content selected by the user, such as a name, a genre, a cast, and a price.

At step S3, the relevant content search module 151 searches the memory 14 for video contents that are relevant to the selected video content based on the acquired associated information. At step S4, the unviewed content search module 152 searches the memory 14 for unviewed contents. At step S5, the viewing deadline search module 153 searches for video contents for which the numbers of days to their viewing deadlines are smaller than or equal to the predetermined number (e.g., seven).

At step S6, the content display module 154 displays a relevant content display screen 21 as shown in FIG. 3B by rearranging the relevant video contents, the unviewed video contents, and the video contents whose deadlines are close according to results of predetermined weighting. Unviewed content indications 21B, pay content indications 21C, deadline indications 21D, and other kinds of indications may be added to respective kinds of video contents. The information processing apparatus 1 may be configured so that the weighting applied to the individual kinds of video contents is set by the user or set at the time of shipment from a factory.

Then, the user selects a desired video content through the relevant content display screen 21 as shown in FIG. 3B using the selection frame 21E and views the desired video.

At step S6, the relevant video contents and the video contents whose deadlines are close may be displayed in different regions in the manner shown in FIG. 3C. Furthermore, the unviewed video contents may be displayed in the display region of the close-deadline video contents.

### Advantages of Embodiment

In the above embodiment, unviewed video contents, pay video contents, and close-deadline video contents are displayed in addition to video contents that are relevant to a video content selected by the user. This prevents the user from failing to view video contents that are high in viewing priority to the user.

Since video contents are rearranged according to results of weighting, the display priority ranks of video contents other than relevant video contents can be set high.

Separately displaying relevant video contents and other video contents in the manner shown in FIG. 3C makes it possible to more clearly present video contents that are high in viewing priority to the user.

Displaying, as pieces of associated information, unviewed content indications 21B, pay content indications 21C, and deadline indications 21D makes it possible to more clearly present video contents that are high in viewing priority to the user.

The information processing apparatus 1 may be configured so that video contents are searched for by using search conditions other than “unviewed,” “pay,” and “close deadline.” The invention can also be applied to contents other than video contents, such as audio contents, image contents, and documents.

What is claimed is:

1. An information processing apparatus comprising:
an associated information acquiring module configured to acquire associated information of content selected from plural contents data;
a first search module configured to search the contents data for first content having first associated information that is relevant to the associated information of the selected content;
a second search module configured to search the contents data for second content having second associated information that satisfies a given condition; and
a content display module configured to display the first content and the second content.

2. The information processing apparatus of claim 1, wherein the content display module is configured to:
apply weighting to the first content and the second content;
rearrange the first content and the second content according to the result of the weighting; and
display the rearranged first and second content.

3. The information processing apparatus of claim 1, wherein the content display module is configured to separately display the first content and the second content.

4. The information processing apparatus of claim 1, wherein the content display module is configured to display the second associated information together with the second content.

5. An information processing method comprising:
acquiring associated information of content selected from plural contents data;
searching the contents data for first content having first associated information that is relevant to the associated information of the selected content;
searching the contents data for second content having second associated information that satisfies a given condition; and
displaying the first content and the second content.
